(19) United States
(12) Patent Application Publication
(10) Pub. No.: US 2023/0186600 A1
(43) Pub. Date: Jun. 15, 2023

(54) METHOD OF CLUSTERING USING ENCODER-DECODER MODEL BASED ON ATTENTION MECHANISM AND STORAGE MEDIUM FOR IMAGE RECOGNITION

(71) Applicant: VINAI ARTIFICIAL INTELLIGENCE APPLICATION AND RESEARCH JOINT STOCK COMPANY, Ha Noi (VN)

(72) Inventors: Xuan Bac NGUYEN, Ha Noi (VN); Duc Toan BUI, Ha Noi (VN); Hai Hung BUI, Ha Noi (VN)

(21) Appl. No.: 17/894,988

(22) Filed: Aug. 24, 2022

(30) Foreign Application Priority Data
Dec. 9, 2021 (VN) 1-2021-07930

(51) Int. Cl. G06V 10/762; G06V 10/77; G06V 10/82; G06F 7/24

(52) U.S. Cl. CPC G06V 10/762; G06V 10/7715; G06V 10/82; G06F 7/24

(57) ABSTRACT

A method of clustering using encoder-decoder model based on attention mechanism extracts image features, clusters to form image feature vector clusters, and based on the cosine similarity score between the image feature vectors to arrange each image feature vector cluster into an image feature vector sequence. The image feature vector sequence includes cosine distance encoding vectors concatenated with respective image feature vectors and is used as the input data sequence in encoder and decoder neural network models to generate an output data sequence from the input data sequence. The output data sequence is a binary sequence having values of 1 or 0 at a position denoting that the image corresponding to the position is or is not in the same cluster with respect to the center image of the cluster.

### CROSS-REFERENCE TO RELATED APPLICATION

The present application claims priority from Vietnamese Application No. 1-2021-07930 filed on Dec. 9, 2021, which is incorporated herein by reference in its entirety.

### TECHNICAL FIELD

The present invention belongs to the field of artificial intelligence and refers to a method of clustering using encoder-decoder model based on attention mechanism, and to a storage medium comprising a computer program to perform the method. More particularly, the method of clustering using encoder-decoder model based on attention mechanism generates an input data sequence from the image feature clusters using the information on the cosine similarity score, for decoding into an output data sequence through encoder and decoder neural networks, wherein each position in the output data sequence may correspond to one image, and based on a value at a position in the output data sequence to recognize or classify the image.

### RELATED ART

The image recognition technique, more particularly, classification (or clustering) of a human face image or a landmark image (which may be generally referred to as visual classification), has been gaining great concerns in machine learning. The solutions therefor, such as human face image or landmark image classification, may be divided into three main groups, including non-supervised learning visual classification, semi-supervised learning visual classification, and supervised learning visual classification.

Based on that it is easy to collect features of the visual data, in practice it is thus possible to access huge databases of visual images. However, it could be said that the exploitation of the information from these visual images is relatively difficult, such as in notation (e.g., extraction of the features in an image for presentation as image-associated information, image recognition, image classification, image clustering, or the like), for example, the reason being that there are too many complicated factors that may influence the visual images, e.g., brightness, shooting poses, depended on practical shooting circumstances. Therefore, it is essentially important and necessary to study, propose, and provide parameterized models for performing information exploitation of the visual images, e.g., visual image classification, whose performance is substantively enhanced.

One of the widely known models includes GCN networks (Graph Convolutional Network), which solve the problem of visual classification by way of non-supervised learning. The GCN networks uses the same similarity concepts in spectral graph theory to design parameterized extractors as suitable in the CNN networks (Convolutional Neural Network), and has been shown as one of the most efficient methods in solving the classification of complicated samples. Some examples of GCN networks were disclosed in the journals of the titles “Learning to cluster faces via confidence and connectivity estimation”, by Lei Yang et al, published in the Proceedings of IEEE Conference on computer vision and pattern recognition, 2020; and “Learning to cluster faces on an affinity graph”, by Lei Yang et al, published in the Proceedings of IEEE Conference on computer vision and pattern recognition, 2019.

In general, GCN networks aim at generating affinity graphs, using the image feature vectors sampled in the visual image database as the vertices, wherein the adjacent vertices are joined together based on the cosine similarity score between the image feature vectors. The graph with said similarity is usually a large-scale graph, which may contain millions of graph vertices, and thus the GCN networks are assumed to have a large computational volume, and require high memory usage. In addition, these networks are quite sensitive to hard and noisy samples.

Therefore, there is a demand for an improved solution in association with image recognition, which may minimize the requirements of memory usage and computational volume, and achieve great results even with hard and noisy samples.

### SUMMARY

The object of the present invention is to provide a method of clustering using encoder-decoder model based on attention mechanism, which may overcome one or some of the above-mentioned problems.

Another object of the present invention is to provide a method of clustering using encoder-decoder model based on attention mechanism, which may technically reduce the requirements of memory usage and computational volume, and technically achieve great results even with hard and noisy samples.

It should be understood that the present invention is not limited to the above-described objects. In addition to these objects, the present invention may also include others that will be obvious to the ordinary person, specified or encompassed in the description below.

To achieve one or some of the above objects, the present invention provides a method of clustering using encoder-decoder model based on attention mechanism, the method comprising:

extracting image features from an image database X consisting of multiple images xᵢ, by an image feature extracting model, to obtain an image feature dataset comprising image feature vectors fᵢ, wherein each image feature vector fᵢ corresponds to one image xᵢ in the said image database X;

clustering the image feature vectors sampled from the said image feature dataset into image feature clusters Cᵢ based on the cosine similarity scores s_{i,j} between the image feature vectors fᵢ and fⱼ, wherein each image feature cluster Cᵢ has a center image feature vector;

arranging the image feature vectors fᵢ in each image feature cluster Cᵢ into an image feature vector sequence Sᵢ in an ascending or descending order based on the cosine similarity scores s_{i,j} of the image feature vectors compared with the center image feature vector in the same said image feature cluster Cᵢ;

generating cosine distance encoding vectors eₜ from the components such as the cosine similarity scores s_{i,j} where each cosine distance encoding vector eₜ corresponds to an image feature vector fₜ in the image feature cluster Cᵢ and the cosine similarity scores s_{i,j} forming the cosine distance encoding vector eₜ are the cosine similarity scores between the image feature vectors and the image feature vector fₜ in the same said image feature cluster Cᵢ;

concatenating the image feature vector fₜ with the respective cosine distance encoding vector eₜ to form a respective cosine-distance-encoding-information-containing image feature vector fₜ*;

generating a cosine-distance-encoding-information-containing image feature vector sequence Sᵢ* in correspondence with each image feature cluster Cᵢ, where the components of the cosine-distance-encoding-information-containing image feature vector sequence Sᵢ* are the cosine-distance-encoding-information-containing image feature vectors fₜ* in correspondence with the image feature vectors fₜ belonging to a respective image feature cluster Cᵢ, and the cosine-distance-encoding-information-containing image feature vectors fₜ* are arranged in an ascending or descending order based on the cosine similarity scores s_{i,j} of the image feature vectors compared with the center image feature vector in the same said image feature cluster Cᵢ;

using the cosine-distance-encoding-information-containing image feature vector sequence Sᵢ* as the input data sequence of an encoder neural network, wherein the encoder neural network is configured to generate a respective encoded representation for each input in the input data sequence by using an attention mechanism, which shows the attention in the encoded representations of the input data sequence;

decoding, by a decoder neural network, to generate an output data sequence, wherein the decoder neural network is configured to receive the encoded representations as the input data for decoding into the output data sequence.

According to an embodiment, the step that the encoder neural network generates a respective encoded representation for each input in the input data sequence by using an attention mechanism, which shows the attention in the encoded representations of the input data sequence comprises:

projecting the cosine-distance-encoding-information-containing image feature vector sequence Sᵢ* into at least one sub-space, wherein for each sub-space, perform the operations of:
determining first, second, and third trainable matrices;
projecting the cosine-distance-encoding-information-containing image feature vector sequence Sᵢ* into first, second, and third super spaces to generate first, second, and third super space features based on the first, second, and third trainable matrices, respectively;
calculating the attention scores r_{i,j} between the cosine-distance-encoding-information-containing image feature vector fᵢ* and the cosine-distance-encoding-information-containing image feature vectors fⱼ* in the cosine-distance-encoding-information-containing image feature vector sequence Sᵢ* based on the first super space feature of the cosine-distance-encoding-information-containing image feature vector fᵢ* and the second super space features of the cosine-distance-encoding-information-containing image feature vectors fⱼ*; and
generating a sub-space output of the cosine-distance-encoding-information-containing image feature vector fᵢ* by calculating a weighted sum of the third super space features of the cosine-distance-encoding-information-containing image feature vectors fⱼ*, wherein the weights assigned to the third super space features are respective attention scores r_{i,j};

linearly transforming a concatenation result of the sub-space outputs of the cosine-distance-encoding-information-containing image feature vector sequence Sᵢ* in correspondence with each sub-space to obtain an attention output; and

generating the encoded representations based on the attention output.

Preferably, the output data sequence of the decoder neural network is a binary sequence yᵢ with a length in correspondence with that of the cosine-distance-encoding-information-containing image feature vector sequence Sᵢ*, where the value at the t^{th} position of the binary sequence yᵢ being 1 denotes the t^{th} image feature vector has the same label as the center image feature vector in the same said image feature cluster Cᵢ, and the value at the t^{th} position of the binary sequence yᵢ being 0 denotes the t^{th} image feature vector does not have the same label as the center image feature vector in the same said image feature cluster Cᵢ.

The cosine distance encoding vector eₜ is determined through the following expression:

$${e}_{t} = {\{ {s}_{t , i} \}}_{i = 1}^{k}$$

where s_{t,i} is the cosine similarity score between the i^{th} image feature vector and the t^{th} image feature vector.

The cosine-distance-encoding-information-containing image feature vector fₜ* is determined through the following expression:

fₜ*=concat(fₜ,eₜ)

where concat is a function that concatenates two vectors into one vector.

The said encoder neural network and decoder neural network are trained using a target function which is determined through the following expression:

$${ℒ}_{i} ( {\hat{𝓎}}_{i} , {𝓎}_{i} ) = - {{\sum }^{k}}_{t = 1} [ {𝓎}_{i}^{t} ⨯ log ( σ ( {\hat{𝓎}}_{i}^{t} ) ) + ( 1 - {𝓎}_{i}^{t} ) ⨯ log ( 1 - σ ( {\hat{𝓎}}_{i}^{t} ) ) ]$$

where σ is the sigmoid function.

Preferably, the said trained image feature extracting model uses two datasets consisting of a labeled dataset D_{L}, and an unlabeled dataset D_{U}.

In another aspect, the present invention provides a storage medium comprising a computer program which includes instructions that, when executed, will cause the computer to perform the said method of image cluttering.

### BRIEF DESCRIPTION OF THE DRAWINGS

FIG. 1 is a flowchart showing a method of clustering using encoder-decoder model based on attention mechanism according to a preferred embodiment of the present invention;

FIG. 2 is a schematic diagram showing a way to rearrange the image feature clusters into a sequence according to a preferred embodiment of the present invention;

FIG. 3 is a screenshot representing a routine showing a sorter G; and

FIG. 4 is a block diagram showing a method of clustering using encoder-decoder model based on attention mechanism according to a preferred embodiment of the present invention.

### DETAILED DESCRIPTION

Below, the advantages, effects, and substance of the present invention may be explained through the detailed description of preferred embodiments with reference to the appended figures. However, it should be understood that these embodiments are only described by way of example to clarify the spirit and advantages of the present invention, without limiting the scope of the present invention according to the described embodiments.

In general, as described below, the method of clustering using encoder-decoder model based on attention mechanism aims at classifying the images or visual data, e.g., recognizing whether the images belong to the same cluster, more particularly, whether human face photos are of the same shooting poses, whether the landmark images are of the same photos of lakes, old castles, etc., for example. However, it should be understood that the techniques or principles in accordance with the present invention are not limited to image or visual data classification, but may be applied in a variety of image recognition applications, such as annotation or labeling for images or visual data.

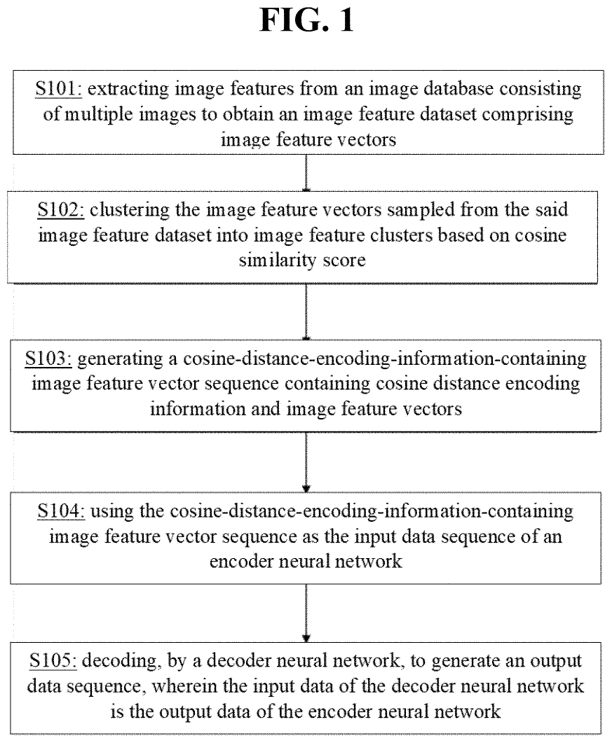

FIG. 1 represents a method of clustering using encoder-decoder model based on attention mechanism according to a preferred embodiment of the present invention.

As shown in the figure, the method of clustering using encoder-decoder model based on attention mechanism according to the preferred embodiment comprises the steps described below.

Step S101: extracting image features from an image database to obtain image feature vectors.

Herein, for ease of description and representation, the image database is referred to as the image database X consisting of multiple images xᵢ, the image feature vectors are referred to as the image feature vectors fᵢ, with each image feature vector fᵢ in correspondence with one image xᵢ in the said image database X.

In this step, the extracting of the image features from the image database X consisting of multiple images xᵢ may be performed through an image feature extracting model M. Using the image feature extracting model M, the input image xᵢ belonging to the image database (e.g., with the dimension of h×w×3, wherein h denotes the height, and w denotes the width of image) is introduced into the image feature extracting model M to extract or capture visual features.

In a particular example, the visual features are image feature vectors fᵢ with the dimension of 1×d, wherein d is the feature dimension of each extracted image by the image feature extracting model M. For convenience, the image feature vectors fᵢ may be represented as fᵢ=M(xᵢ).

In general, the image feature extracting models are already known, and widely used, such as CNN models, for example. Specific description of the image feature extracting models is intended for omission to focus into allegedly more important contents of the present invention.

According to a preferred embodiment, the use of the image feature extracting model M is maximized on efficiency by using two datasets consisting of a labeled dataset D_{L}, and an unlabeled dataset D_{U} during training for the image feature extracting model M. First, the image feature extracting model M is trained using the labeled dataset D_{L} by way of typical supervised learning. Then, the image feature extracting model M after being trained by the labeled dataset D_{L} is used to trigger extracted training samples in the unlabeled dataset D_{U}. The training may correspond to semi-supervised learning, wherein the unlabeled dataset D_{U} is much greater than the labeled dataset D_{L}.

Step S102: clustering the image feature vectors sampled from the said image feature dataset into image feature clusters based on the cosine similarity score.

Herein, for ease of description and representation, the image feature cluster is referred to as an image feature cluster Cᵢ, the cosine similarity score is referred to as a cosine similarity score s_{i,j}, the cosine similarity score is the cosine similarity score s_{i,j} between the image feature vectors fᵢ and fⱼ.

The cosine similarity score between two vectors is a known mathematical feature between two vectors. For example, the cosine similarity score between two vertices vᵢ, vⱼ of the similarity graph represented by a adjacency matrix W, which is the cosine of the angle between two vectors consisting of a vector denoted by the i^{th} row and j^{th} row of the adjacency matrix W, denoted as Wⁱ, W^{j}.

The cosine similarity score is determined as follows:

$${σ}_{ij} = \frac{{W}^{i} . {W}^{j}}{‖ {W}^{i} ‖ ‖ {W}^{j} ‖} .$$

According to a preferred embodiment, clustering of the said image feature vectors is performed by using a k-nearest neighbors algorithm based on the cosine similarity score, referred to as a k-nearest neighbors model K.

Each image feature cluster Cᵢ has a center image feature vector fᵢ, and may be represented as Cᵢ=K(fᵢ, F, k), wherein F=M(X) is a feature subset extracted from the image database X, and k is the number of nearest neighbors.

The image feature clusters Cᵢ form a set of image feature clusters C, which may be represented as C={Cᵢ}ᵢ₌₁^{N}.

Step S103: generating a cosine-distance-encoding-information-containing image feature vector sequence consisting of cosine distance encoding information and image feature vectors.

According to a preferred embodiment, a cosine-distance-encoding-information-containing image feature vector sequence consisting of cosine distance encoding information and image feature vectors is a cosine-distance-encoding-information-containing image feature vector sequence Sᵢ* in correspondence with each image feature cluster Cᵢ, wherein the components of the cosine-distance-encoding-information-containing image feature vector sequence Sᵢ* are the cosine-distance-encoding-information-containing image feature vectors fₜ* in correspondence with the image feature vectors fₜ belonging to a respective image feature cluster Cᵢ, and the order of the cosine-distance-encoding-information-containing image feature vectors fₜ* is based on the ascending or descending cosine similarity scores s_{i,j} of the image feature vectors compared with the center image feature vector in the same said image feature cluster Cᵢ.

In order to generate cosine-distance-encoding-information-containing image feature vectors fₜ*, firstly the cosine distance encoding vectors eₜ are formed from the components such as the cosine similarity scores s_{i,j}, wherein each cosine distance encoding vector eₜ corresponds to an image feature vector fₜ in the image feature cluster Cᵢ, and the cosine similarity scores s_{i,j} forming the cosine distance encoding vector eₜ are the cosine similarity scores between the image feature vectors and the image feature vector fₜ in the same said image feature cluster Cᵢ; Then, concatenating the image feature vector fₜ with the respective cosine distance encoding vector eₜ to form a respective cosine-distance-encoding-information-containing image feature vector fₜ*.

According to a preferred embodiment, the cosine-distance-encoding-information-containing image feature vector sequence Sᵢ* is generated by:

arranging the image feature vectors fₜ in each image feature cluster Cᵢ into an image feature vector sequence Sᵢ in an ascending or descending order based on the cosine similarity scores s_{i,j} of the image feature vectors compared with the center image feature vector in the same said image feature cluster Cᵢ, and

concatenating the image feature vector fₜ with the respective cosine distance encoding vector eₜ, at each position of the t^{th} image feature vector in the image feature vector sequence Sᵢ, to form a cosine-distance-encoding-information-containing image feature vector fₜ* to form the said cosine-distance-encoding-information-containing image feature vector sequence Sₜ*.

It should be understood that the present invention is not limited to the preferred embodiments, however, the cosine-distance-encoding-information-containing image feature vectors Sᵢ* may be generated without generating the image feature vector sequence Sᵢ, e.g., the cosine-distance-encoding-information-containing image feature vectors fₜ* may be generated first, and then arranged into a sequence to form a cosine-distance-encoding-information-containing image feature vector sequence Sᵢ*, for example.

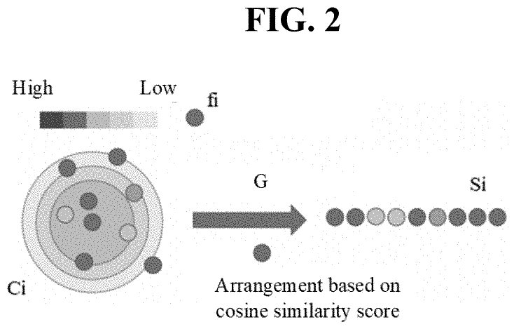

According to a preferred embodiment, as shown in FIG. 2, the image feature vector sequence Sᵢ generated from the image feature cluster Cᵢ consists of an image feature vectors fᵢ as the center through arrangement by sorter G, represented as Sᵢ=G(Cᵢ).

According to the preferred embodiment, the cosine similarity scores s_{i,j} between the image feature vectors fⱼ in a cluster with the image feature vector fᵢ as the center of the cluster are calculated, and the image feature vectors fⱼ will be arranged in a descending order of the cosine similarity scores to form the sequence.

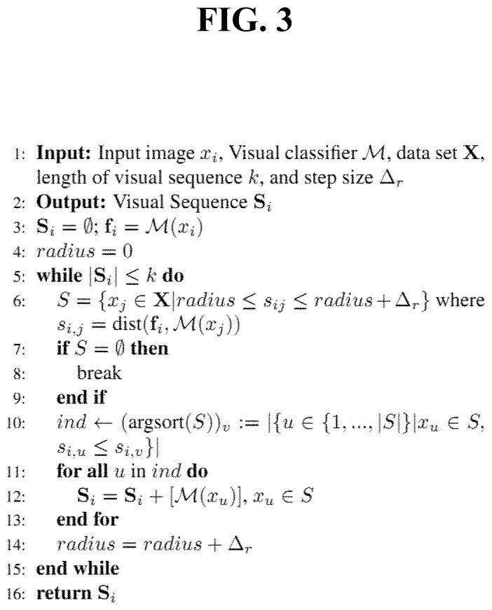

In order to provide more coherent information, a screenshot of the routine presenting the sorter G is shown in FIG. 3 for reference.

According to a preferred embodiment, the cosine distance encoding vector eₜ is determined through the following expression:

$${e}_{t} = {\{ {s}_{t , i} \}}_{i = 1}^{k}$$

wherein s_{t,i} is the cosine similarity score between the i^{th} image feature vector and the t^{th} image feature vector.

The cosine-distance-encoding-information-containing image feature vector fₜ* is determined through the following expression:

fₜ*=concat(fₜ,eₜ)

where concat is a function that concatenates two vectors into one vector.

Step S104: using the cosine-distance-encoding-information-containing image feature vector sequence as the input data sequence of an encoder neural network.

In this step, the encoder neural network is configured to generate a respective encoded representation for each input in the input data sequence by using an attention mechanism, which shows the attention in the encoded representations of the input data sequence. In order to capture the attention in the encoded representations of the input data sequence, the cosine-distance-encoding-information-containing image feature vector sequence Sᵢ* is projected into at least one sub-space. For each sub-space, the first, second, and third trainable matrices are determined. The first, second, and third trainable matrices may, respectively, be referred to as query matrix W^{Q}ϵR^{d×d′}, key matrix W^{K}ϵR^{d×d′}, and value matrix W^{V}ϵR^{d×d′}. Then, the cosine-distance-encoding-information-containing image feature vector sequence Sᵢ* is projected into first, second, and third super spaces (referred to as query, key and value super spaces, respectively) to generate first, second, and third super space features (referred to as query super space feature Q, key super space feature K and value super space feature V, respectively) based on the first, second, and third trainable matrices, respectively, according to Equations:

Q=Sᵢ*W^{Q},QϵR^{d×d′}

K=Sᵢ*W^{K},KϵR^{d×d′}

V=Sᵢ*W^{v},VϵR^{d×d′}

Then, the attention scores r_{i,j} between the cosine-distance-encoding-information-containing image feature vector fᵢ* and the cosine-distance-encoding-information-containing image feature vectors fⱼ* in the cosine-distance-encoding-information-containing image feature vector sequence Sᵢ* are calculated based on the first super space feature of the cosine-distance-encoding-information-containing image feature vector fᵢ* and the second super space features of the cosine-distance-encoding-information-containing image feature vectors fⱼ* according to Equation:

$${r}_{i , j} = \frac{\text{?}}{{\sum }_{j = 1}^{k} \text{?}}$$

$$\text{?} \text{indicates text missing or illegible when filed}$$

The sub-space output Zᵢ of the cosine-distance-encoding-information-containing image feature vector fᵢ* is generated by calculating a weighted sum of the third super space features Vⱼ of the cosine-distance-encoding-information-containing image feature vectors fⱼ*, wherein the weights assigned to the third super space features are respective attention scores r_{i,j}:

Zᵢ=Σⱼ₌₁^{k}r_{i,j}·Vⱼ.

Z=Att(Q,K,V)={Zᵢ}ᵢ₌₁^{k}

If the sub-space number is m, then the feature dimension of each sub-space is

$${d}^{′} = \frac{d}{m} .$$

The sub-space outputs of the cosine-distance-encoding-information-containing image feature vector sequence Sᵢ* in correspondence with each sub-space Z_{s,i} are calculated as follows:

Z_{s,i}=Att(Q_{s,i},K_{s,i},V_{s,i}),1≤i≤m

A concatenation result of the sub-space outputs of the cosine-distance-encoding-information-containing image feature vector sequence Sᵢ* in correspondence with each sub-space is linearly transformed to obtain an attention output Z_{M}:

Z_{M}=concat(Z_{s,1}, . . . ,Z_{s,m})·W^{M}

Where W^{M} is an additional weight matrix.

The encoder neural network may generate encoded representations based on the attention output Z_{M}. According to an embodiment of the present invention, the encoder neural network includes a point-wise feed forward network (FFN) to receive the attention output Z_{M}.

Step S105: decoding, by a decoder neural network, to generate an output data sequence, wherein the input data of the decoder neural network are the output data of the encoder neural network.

Herein, the input data of the decoder neural network or the output data of the encoder neural network are encoded representations.

According to a preferred embodiment, the output data sequence of the decoder neural network is a binary sequence yᵢ with a length in correspondence with that of the cosine-distance-encoding-information-containing image feature vector sequence Sᵢ*, where the value at the t^{th} position of the binary sequence yᵢ being 1 denotes the t^{th} image feature vector has the same label as the center image feature vector in the same said image feature cluster Cᵢ, and the value at the t^{th} position of the binary sequence yᵢ being 0 denotes the t^{th} image feature vector does not have the same label as the center image feature vector in the same said image feature cluster Cᵢ.

The said encoder neural network and decoder neural network are trained using the target function which may be determined through the following expression:

$${ℒ}_{i} ( {\hat{𝓎}}_{i} , {𝓎}_{i} ) = - {{\sum }^{k}}_{t = 1} [ {𝓎}_{i}^{t} ⨯ log ( σ ( {\hat{𝓎}}_{i}^{t} ) ) + ( 1 - {𝓎}_{i}^{t} ) ⨯ log ( 1 - σ ( {\hat{𝓎}}_{i}^{t} ) ) ]$$

where σ is the sigmoid function.

In general, the said encoder and decoder neural networks are already known and may be similarly applied as the encoder and decoder neural networks used in attention-based encoder-decoder models. An example of models in this form is provided in a journal with the title “Attention is all you need”, by Ashish Vaswani et al. Another example of models in this form is provided in U.S. Ser. No. 10/452,978 B2, U.S. Ser. No. 10/719,764 B2, U.S. Ser. No. 10/839,259 B2, U.S. Ser. No. 10/956,819 B2. The whole contents of the documents are intended to be introduced herein for reference and may be incorporated into the solution provided in accordance with the present invention by any known means.

The features and operational principles of the encoder and decoder neural networks of the present invention are completely similar to those of the encoder and decoder neural networks provided or used in said journals and patent documents. Thus, specific descriptions of the encoder and decoder neural network is intended for omission to focus into allegedly more important contents of the present invention.

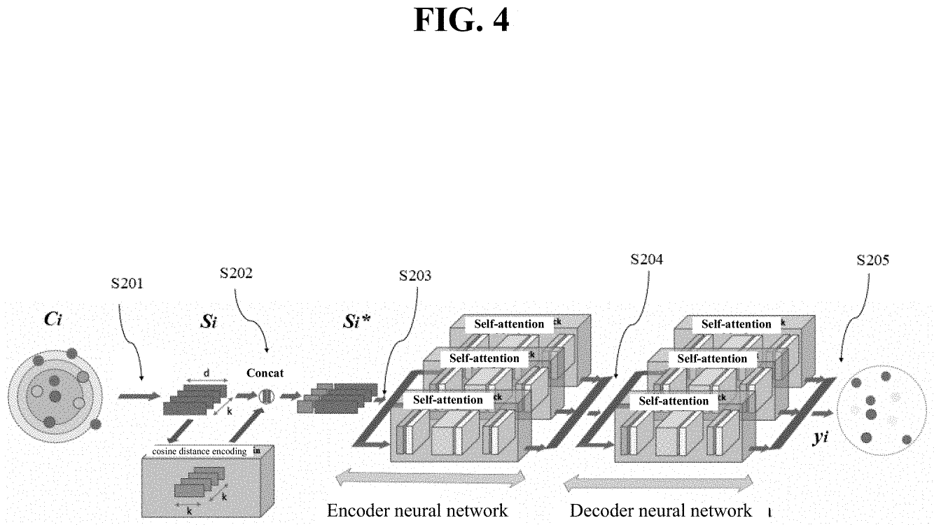

As shown in FIG. 4, the method of clustering using encoder-decoder model based on attention mechanism is illustrated through steps S201-S205, described in greater detail below.

In step S201, the image feature cluster Cᵢ (including the image feature vectors fᵢ with the dimension of 1×d) is rearranged into an image feature vector sequence Sᵢ.

Next, in step S202, at each position in the image feature vector sequence Sᵢ, the cosine distance encoding vector eₜ (with the dimension of 1×k) will be concatenated with a respective image feature vector fₜ to form a cosine-distance-encoding-information-containing image feature vector sequence Sᵢ*, wherein each component of the cosine-distance-encoding-information-containing image feature vector sequence Sᵢ* is a cosine-distance-encoding-information-containing image feature vector fₜ* with the dimension of 1×(k+d), which is concatenation of the cosine distance encoding vector eₜ and a respective image feature vector fₜ.

In step S203, the cosine-distance-encoding-information-containing image feature vector sequence Sᵢ* is used as the input data sequence of the encoder neural network to generate a respective encoded representation for each input in the input data sequence by using an attention mechanism (self-attention), which shows the attention in the encoded representations of the input data sequence.

Next, in step S204, the encoded representations generated in step S203 above are used as the input data of the decoder neural network, to generate an output data sequence yᵢ as a binary sequence.

Finally, in step S205, the output data sequence yᵢ is combined to form a recognized output image feature cluster.

Regarding the method of clustering using encoder-decoder model based on attention mechanism described above, the image recognition models, which use the method of clustering using encoder-decoder model based on attention mechanism provided by the present invention, may be understood as a class of models to perform image recognition (e.g., image classification), including image feature extracting models, encoder neural networks, decoder neural networks, and relevant components to perform the functions of image recognition, such as sorter G for performing arrangement, cosine distance encoders to perform cosine distance encoding, memories, and calculators, for example.

From the above, the present invention has been described in detail according to the preferred embodiments. It is obvious that a person of ordinary may easily generate variations and modifications to described embodiments. Thus, these variations and modifications do not fall outside the scope of the present invention as determined in the appended claims.

What is claimed is:

1. A method of clustering using encoder-decoder model based on attention mechanism, the method comprising:
extracting image features from an image database X consisting of multiple images xᵢ, by an image feature extracting model, to obtain an image feature dataset comprising image feature vectors fᵢ, wherein each image feature vector fᵢ corresponds to one image xᵢ in the said image database X;
clustering the image feature vectors sampled from the said image feature dataset into image feature clusters Cᵢ based on cosine similarity scores s_{i,j} between the image feature vectors fᵢ and fⱼ, wherein each image feature cluster Cᵢ has a center image feature vector;
arranging the image feature vectors fᵢ in each image feature cluster Cᵢ into an image feature vector sequence Sᵢ in an ascending or descending order based on the cosine similarity scores s_{i,j} of the image feature vectors compared with the center image feature vector in the same said image feature cluster Cᵢ;
generating cosine distance encoding vectors eₜ from the components such as the cosine similarity scores s_{i,j}, where each cosine distance encoding vector eₜ corresponds to an image feature vector fₜ in the image feature cluster Cᵢ and the cosine similarity scores s_{i,j} forming the cosine distance encoding vector eₜ are the cosine similarity scores between the image feature vectors and the image feature vector fₜ in the same said image feature cluster Cᵢ;
concatenating the image feature vector fₜ with the respective cosine distance encoding vector eₜ to form a respective cosine-distance-encoding-information-containing image feature vector fₜ*;
generating a cosine-distance-encoding-information-containing image feature vector sequence Sᵢ* in correspondence with each image feature cluster Cᵢ, wherein the components of the cosine-distance-encoding-information-containing image feature vector sequence Sᵢ* are the cosine-distance-encoding-information-containing image feature vectors fₜ* in correspondence with the image feature vectors fₜ belonging to a respective image feature cluster Cᵢ, and the cosine-distance-encoding-information-containing image feature vectors fₜ* are arranged in an ascending or descending order based on the cosine similarity scores s_{i,j} of the image feature vectors compared with the center image feature vector in the same said image feature cluster Cᵢ;
using the cosine-distance-encoding-information-containing image feature vector sequence Sᵢ* as the input data sequence of an encoder neural network, wherein the encoder neural network is configured to generate a respective encoded representation for each input in the input data sequence by using an attention mechanism, which shows the attention in the encoded representations of the input data sequence; and
decoding, by a decoder neural network, to generate an output data sequence, wherein the decoder neural network is configured to receive the encoded representations as the input data for decoding into the output data sequence.

2. The method according to claim 1, wherein the step that the encoder neural network generates the respective encoded representation for each input in the input data sequence by using an attention mechanism, which shows the attention in the encoded representations of the input data sequence, comprises:
projecting the cosine-distance-encoding-information-containing image feature vector sequence Sᵢ* into at least one sub-space, wherein for each sub-space, perform the operations of:
determining first, second, and third trainable matrices;
projecting the cosine-distance-encoding-information-containing image feature vector sequence Sᵢ* into first, second, and third super spaces to generate first, second, and third super space features based on the first, second, and third trainable matrices, respectively;
calculating the attention scores r_{i,j} between the cosine-distance-encoding-information-containing image feature vector fᵢ* and the cosine-distance-encoding-information-containing image feature vectors fⱼ* in the cosine-distance-encoding-information-containing image feature vector sequence Sᵢ* based on the first super space feature of the cosine-distance-encoding-information-containing image feature vector fᵢ* and the second super space features of the cosine-distance-encoding-information-containing image feature vectors fⱼ*; and
generating a sub-space output of the cosine-distance-encoding-information-containing image feature vector fᵢ* by calculating a weighted sum of the third super space features of the cosine-distance-encoding-information-containing image feature vectors fⱼ*, wherein the weights assigned to the third super space features are respective attention scores r_{i,j};
linearly transforming a concatenation result of the sub-space outputs of the cosine-distance-encoding-information-containing image feature vector sequence Sᵢ* in correspondence with each sub-space to obtain an attention output; and
generating the encoded representations based on the attention output.

3. The method according to claim 1, wherein the output data sequence of the decoder neural network is a binary sequence yᵢ with a length in correspondence with that of the cosine-distance-encoding-information-containing image feature vector sequence Sᵢ*, where the value at the t^{th} position of the binary sequence yᵢ being 1 denotes the t^{th} image feature vector has the same label as the center image feature vector in the same said image feature cluster Cᵢ, and the value at the t^{th} position of the binary sequence yᵢ being 0 denotes the t^{th} image feature vector does not have the same label as the center image feature vector in the same said image feature cluster Cᵢ.

4. The method according to claim 1, wherein the cosine distance encoding vector eₜ is determined through the following expression:
$${e}_{t} = {\{ {s}_{t , i} \}}_{i = 1}^{k}$$
where s_{t,i} is the cosine similarity score between the i^{th} image feature vector and the t^{th} image feature vector, and
wherein the cosine-distance-encoding-information-containing image feature vector fₜ* is determined through the following expression:
fₜ*=concat(fₜ,eₜ)
where concat is a function that concatenates two vectors into one vector.

5. The method according to claim 1, wherein the said encoder neural network and decoder neural network are trained using a target function which is determined through the following expression:
$${ℒ}_{i} ( {\hat{𝓎}}_{i} , {𝓎}_{i} ) = - {{\sum }^{k}}_{t = 1} [ {𝓎}_{i}^{t} ⨯ log ( σ ( {\hat{𝓎}}_{i}^{t} ) ) + ( 1 - {𝓎}_{i}^{t} ) ⨯ log ( 1 - σ ( {\hat{𝓎}}_{i}^{t} ) ) ]$$
where σ is the sigmoid function.

6. The method according to claim 1, wherein the said trained image feature extracting model uses two datasets consisting of a labeled dataset D_{L}, and an unlabeled dataset D_{U}.

7. A non-transitory computer readable storage medium comprising computer program instructions that, when executed, perform the method according to claim 1.
